(19) United States
(12) Patent Application Publication
(10) Pub. No.: US 2018/0065745 A1
(43) Pub. Date: Mar. 8, 2018

(54) UNMANNED VEHICLES NAVIGATION TERMINATION SYSTEM

(71) Applicant: Flytrex Aviation Ltd., Tel Aviv (IL)

(72) Inventors: Yariv BASH, Tel Aviv (IL); Amit REGEV, Tel Aviv (IL); Vadim ZLOTNIK, Beer Sheva (IL)

(73) Assignee: Flytrex Aviation Ltd., Tel Aviv (IL)

(21) Appl. No.: 15/698,341

(22) Filed: Sep. 7, 2017

Related U.S. Application Data
(60) Provisional application No. 62/384,415, filed on Sep. 7, 2016.

(51) Int. Cl. B64C 39/02; B64D 17/80; B64D 31/04; B64D 31/06

(52) U.S. Cl. CPC B64C 39/024; B64D 17/80; B64C 2201/185; B64D 31/06; B64D 31/04

(57) ABSTRACT

A navigation termination system of an unmanned vehicle (UV) is provided. The system includes a plurality of sensors connected to the UV and configured to detect motion of the UV; a power supply configured to power the movement of the UV; a processing circuitry; and a memory, the memory containing instructions that, when executed by the processing circuitry, configure the system to: determine, based on sensory signals captured by the plurality of sensors, a navigation termination event; and disrupt a connection between the power supply and a motion mechanism of the UV when the navigation termination event occurs.

### CROSS-REFERENCE TO RELATED APPLICATIONS

This application claims the benefit of U.S. Provisional Application No. 62/384,415 filed on Sep. 7, 2016, the contents of which are hereby incorporated by reference.

### TECHNICAL FIELD

The present disclosure relates generally to unmanned vehicles, and more particularly to security measures related to the termination of the navigation of unmanned vehicles.

### BACKGROUND

Unmanned vehicles (UVs) are seeing increased industry use as improvements in fields such as artificial intelligence, battery life, and computational power are made. As an example, companies such as Amazon® are beginning to increasingly use UVs such as drones to deliver packages to customers. As a result, some companies will likely begin to utilize fleets of hundreds or thousands of UVs simultaneously to provide efficient and quick service.

In addition to the technical challenges related to implementing UVs, these vehicles carry regulatory challenges. In particular, regulatory requirements may result in the need to quickly terminate an unmanned vehicle's navigation in a way that would eliminate or minimize human or property damage. Satisfying such a requirement via an on-board system within the UV can be challenging due to, for example, regulatory demands which may differ between jurisdictions and change within a single jurisdiction. Further, certifying individual vehicles to meet regulatory demands can be costly and may restrict availability of certain UVs to autonomous vehicle users.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” or “certain embodiments” may be used herein to refer to a single embodiment or multiple embodiments of the disclosure.

Certain embodiments disclosed herein include a navigation termination system of an unmanned vehicle (UV), including a plurality of sensors connected to the UV and configured to detect motion of the UV; a power supply configured to power the movement of the UV; a processing circuitry; and a memory, the memory containing instructions that, when executed by the processing circuitry, configure the system to: detect, based on sensory signals captured by the plurality of sensors, a navigation termination event; disrupt a connection between the power supply and a motion mechanism of the UV when the navigation termination event occurs.

Certain embodiments disclosed herein also include a method for terminating a navigation system of an unmanned vehicle (UV). The method comprises detecting, by a plurality of sensors connected to the UV, a motion of the UV; determining, based on sensory signals captured by the plurality of sensors, a navigation termination event; and disrupting a connection between the power supply and a motion mechanism of the UV when the navigation termination event occurs.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic diagram of a navigation termination system for an unmanned vehicle arranged according to an embodiment.

FIG. 2 is a schematic illustration of an unmanned vehicle.

FIG. 3A is a schematic illustration of an unmanned vehicle connected to the navigation termination system according to an embodiment.

FIG. 3B is a schematic illustration of the unmanned vehicle connected to the navigation termination system deploying a protective system according to an embodiment.

FIG. 4 is a flowchart illustrating a method for operating navigation termination of an unmanned vehicle according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

In an example embodiment, the unmanned vehicle system navigation termination system includes one or more sensors, a communication circuit, a protection device controller, and a processing circuitry coupled to a memory. The sensors are designed to generate sensory signals related to the operation of an unmanned vehicle (UV). For example, such sensory signals may include accelerometers and global positioning sensors. The system is configured to determine based, in part, on the sensory signals if the navigation termination protocol should be executed. A protection device of the UV is deployed in certain hazardous events, for example, when the connection is disrupted to mitigate the effects of termination of the power supply to the UV.

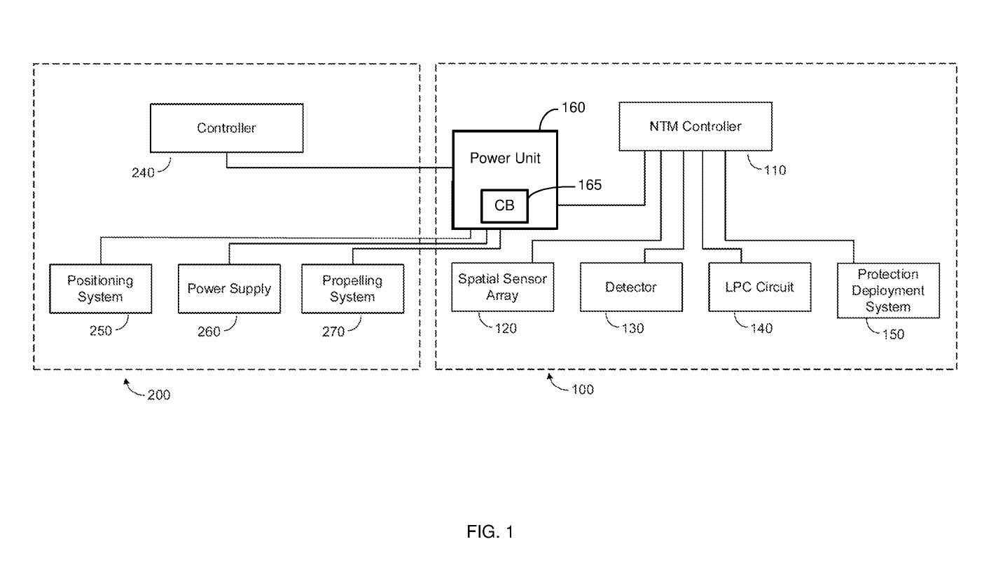

FIG. 1 shows a schematic diagram of a navigation termination system (NTS) 100 communicatively connected to a controller 240 of an unmanned vehicle (UV) 200 according to an embodiment. In FIG. 1, the navigation termination system 100 includes a navigation termination (NT) controller 110, a spatial sensor array 120, a detector 130, a low power communication (LPC) circuit, a protection deployment system 150, and a power unit 160. The UV 200 includes the UV controller 240, a positioning system 250, a power supply 260, and a propelling system 270.

In an embodiment, the UV controller 240 is configured to control various functions of the UV 200. The UV controller 240 includes at least one processing circuitry (not shown) such as, for example, a central processing unit (CPU). The processing circuitry may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

The processing circuitry is coupled via a bus (not shown) to a memory (not shown). The memory may be volatile (e.g., RAM, etc.), non-volatile (e.g., ROM, flash memory, etc.), or a combination thereof. The memory may be configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry to perform the various processes described herein. The memory may also be used as a working scratch pad for the processing circuitry, a temporary storage, and the like.

The positioning system 250 on the UV 200 may be, for example, a global navigation satellite system, such as the Global Positioning System (GPS), GLONASS or Galileo systems. The power supply 260 may include an energy storage (e.g., a rechargeable battery), such as a photovoltaic array (solar panel) coupled with an energy storage. The propelling system 270 is configured to operate the UV. The propelling system 270 may include, for example, one or more motors, an engine, a gear system, axles and the like.

In the example implementation shown in FIG. 1, the UV controller 240 is connected to a power unit 160 of the NTS 100. The power unit 160 includes a circuit breaker 165 for cutting power from the power supply 260 to the propelling system 270. The power unit 160 may further supply power to a navigation terminal (NT) controller 110, from a power supply 260, or an energy storage (such as battery, capacitor, etc) embedded therein. The NT controller 110 be realized as a processing circuitry, examples of which are provided above.

The NTS 100 further includes a spatial sensor array 120. The spatial sensor array 120 may include, in an embodiment, one or more accelerometers configured to detect and measure the movements of the system 100 and/or the UV 200. The NTS 100 may further include a detector 130, such as an optical sensor, a radar system or combinations thereof. The NTS 100 includes a communication circuit, such as a low power communication (LPC) circuit 140. In an embodiment, the LPC circuit 140 may further use an authentication system (not shown) for authenticating received commands. In an embodiment, the authentication system is configured to check if the such commands are received from an authorized user. A command may be, for example, to initiate a termination sequence for the flight of the drone.

In some embodiments, instructions may include a sequence, for example of bits, which is unique to one specific UV. The received instructions may be sent from an authorized node, such as a server or user device, to the NTS 100. The NTS 100 also includes a protection deployment system (PDS) 150. Upon initiating a navigation termination, the NT controller 110 configures a circuit breaker 165 of power unit 160 to break the circuit between the power supply 260 and the propelling system 270. As the vehicle may be a danger to itself and to other property and/or humans, the NT controller 110 initiates the protection deployment system 150.

The PDS 150 includes, in an embodiment, a parachute capable of, for example, decreasing the descent rate of an unmanned aerial vehicle (UAV), or deaccelerating an autonomous car. In some other embodiments, the PDS 150 may include one or more airbags which absorb the energy of the UV upon impact.

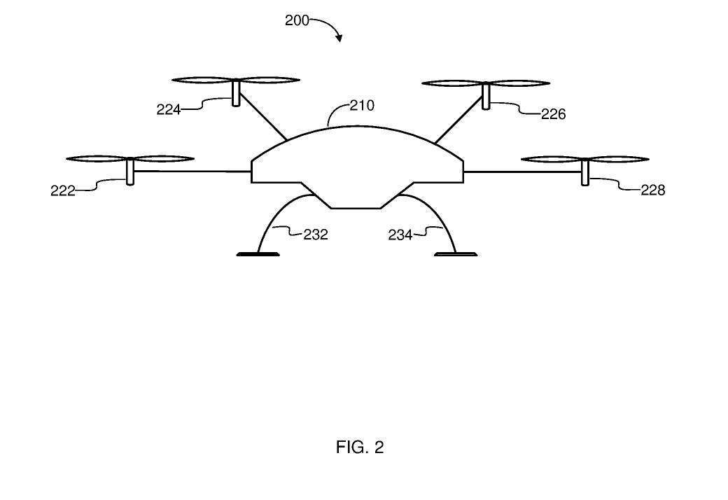

FIG. 2 is an example schematic illustration of the unmanned aerial vehicle (UAV) such as a drone. The UAV 200 includes a body 210, for housing therein a controller, such as UV controller 240 (FIG. 1). The controller may be connected to a communication circuit, such as the LPC circuit 140, for communicating with a control server over a network. In an embodiment, the network may be configured to provide connectivity of various sorts, as may be necessary, including but not limited to, wired and/or wireless connectivity, including, for example, to a local area network (LAN), wide area network (WAN), low power WAN (LPWAN), metro area network (MAN), worldwide web (WWW), Internet, and any combination thereof, as well as wireless connectivity to cellular towers.

In an example configuration, the body 210 is coupled with a plurality of rotors, such as a first rotor 222, second rotor 224, third rotor 226 and fourth rotor 228. It should be noted that the UAV 200 may comprise any number of rotors without departing from the scope of the disclosed embodiments. Typically, one pair of rotors, for example first rotor 222 and third rotor 226, turn clockwise, while a second pair of rotors, for example second rotor 224 and fourth rotor 228, turn counter-clockwise. Typically, the rotors have a fixed pitch, and height, yaw, pitch, and roll are adjusted by applying a thrust to each rotor as the situation requires. In some configurations, the UAV 200 may further include a pair of landing skids 232 and 234. In certain configurations, the landing skids may be equipped with dampers (not shown). Dampers assist in shock absorption from landing the UAV, allowing protection of a UAV payload, and protection of, for example, the controller.

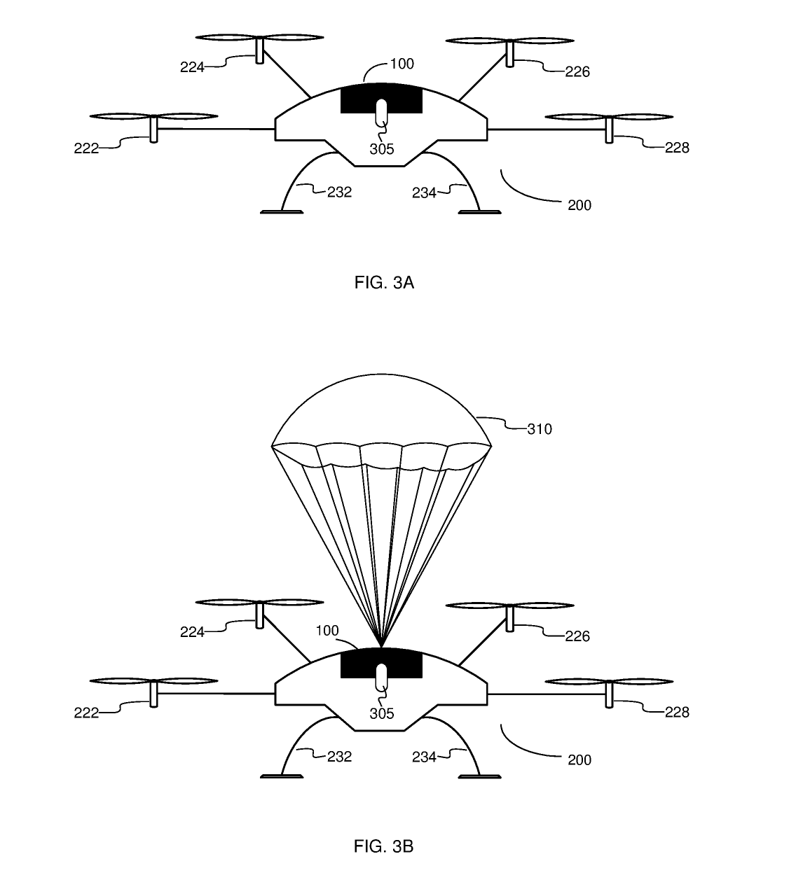

FIG. 3A is an example schematic illustration of the unmanned vehicle 200 connected to a navigation termination system 100 according to an embodiment. Certain UAVs may include a terminal for coupling external devices, such as sensors, cameras, payloads, and the like. The NTS 100 may be physically coupled with the UAV 200 through such a terminal.

In an example embodiment, the NTS 100 be further fastened with a latch 305 to the UAV body 210. In such embodiment, the latch 305 is configured for straightforward coupling and uncoupling of the NTS 100 to and from the UAV 200. In another example embodiment, the NTM 100 may be connected to a bus of the UAV 200 to further receive signals and/or flight information from one or more sensors of the UAV 200. The NTS 100 is configured to receive data from one or more inputs and determine when to initiate a navigation termination protocol, which includes cutting power to the UAV's propelling system and deploying a protection device.

FIG. 3B is an example schematic illustration of the UAV 200 connected to the NTS 100 deploying a protection device 310. In the example schematic diagram shown in FIG. 3B, the protection device 310 is a parachute. Upon determining that the UAV's 300 navigation should be terminated, power to the rotors is cut by the circuit breaker 165, causing the first rotor 222, second rotor 224, third rotor 226 and fourth rotor 228 to cease creating lift.

In this embodiment, the PDS 150 (e.g., of FIG. 1) is configured to deploy a parachute 310 to slow the speed of fall of the UAV 200. In some embodiments, the NTS 100 is configured to initiate the PDS 150 without first initiating a navigation termination protocol. This can be, for example, upon detection of loss of power, or that the UAV 200 is operating in a manner exceeding predefined parameters. In certain embodiments, the NTS 100 may include a power source separate from the UAV 200, so that the NTS 100 may continue to function upon power loss of the UAV 200. In some embodiments, the NTS 100 may detect that the UAV 200 has stopped descending, and, using a location sensor, send a distress beacon periodically, allowing for the UAV 200 to be found and retrieved.

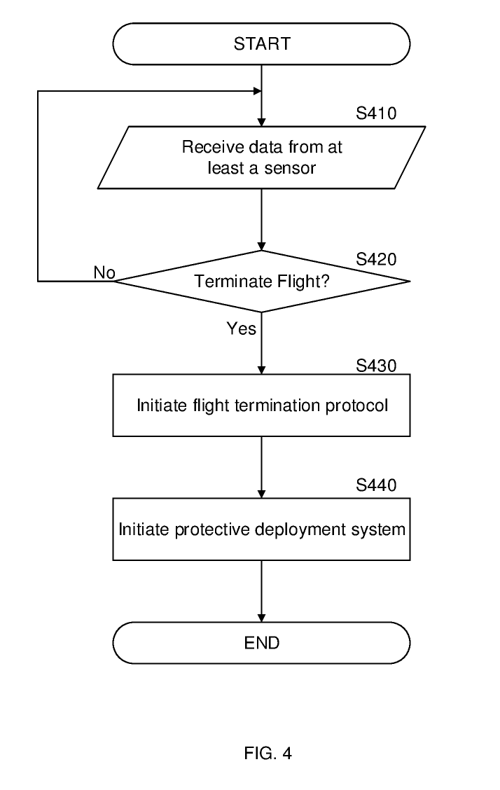

FIG. 4 is an example flowchart 400 illustrating a method for navigation termination of an unmanned vehicle according to an embodiment. The method is performed, for example, by the NTS discussed above with reference to FIGS. 1, 3A and 3B.

At S410, one or sensory signals are received by the NTS 110. In an embodiment, the sensor signals may be received, for example, from a spatial sensor such as an accelerometer, a positioning system such as a GPS, an image sensor, a radar, combinations thereof, and the like. In an embodiment, S410 may further include receiving meteorological data.

At S420 a check is performed by the NTS to determine whether to initiate a flight termination protocol based on the received sensory signal. If so execution continues at S430; otherwise execution continues at S410.

The determination performed based on the received signals attempts to identify navigation termination event. A navigation termination event may be, for example, divergent and/or hazardous event to the UV, surrounding environment, human, and so on. For example, the accelerometer indicates that the UV accelerates when it should be landed, this may be indicative of a divergent event. As another example, when the GPS signal indicates that UV is about to land on a highway may be indicative of a divergent event. Is yet another example, the radar signal provides an indication of a group of people in the landing area, may be indicative of a divergent event.

In certain embodiments, the determination of whether to activate the termination protocols may be the result of receiving a termination command from an authorized node or user. A node may be a computer device, a handheld mobile device, tablet, and the like, which is equipped to be communicatively connected to a network and includes an input device to receive input from a human user. In some embodiments, the determination may include loss of communication between the NTM and an authorized node for a period of time exceeding a first threshold.

The sensory signal may include, but is not limited to, geographical location, direction, acceleration, orientation, speed, wind speed, wind direction, and the like. The sensor data may indicate, e.g., a divergence from a navigation plan of the UAV 200, a location of the divergence, a time of the divergence, and the like. In an embodiment, a divergent event beyond a predetermined threshold will invoke a navigation termination protocol.

In an embodiment, S420 may include determining a type of divergence event. The type of the divergence event may be, but is not limited to, a temporary event or a permanent event. A temporary event may be a single occurrence event such as the passing of a flock of birds, or a non-single occurrence event such as wind or other weather conditions that may last for hours or days. A permanent event may be, but is not limited to, a non-moving obstacle such as a building or any other event that may affect navigation which does not change frequently (e.g., every few days). For example, a permanent event may occur when a height of a building has changed such that all subsequently generated navigation plans should account for the change.

Permanent events, single occurrence temporary events, and non-single occurrence temporary events may be defined with respect to sensor data. In some embodiments, the type of the divergence event is determined based on feedback received from multiple UVs, aircrafts (e.g., planes, helicopters, etc.), or both. Determining the type of divergence event based on navigation feedback from multiple vehicles allows for more accurate determination of divergence events. For example, a divergence event indicated by motion sensor data may be a passing object (e.g., a bird) or may be a static object (e.g., a building). When the divergence event is a bird at a specific location, navigation feedback from multiple UVs navigating through that location will typically only indicate one instance of the divergence event at the location. When the divergence event is a building at a location, navigation feedback from multiple UVs navigating through the location will indicate multiple instances of the divergence event.

At S430, a flight navigation termination protocol is initiated when the divergence event is determined to surpass a threshold, such that a navigation termination protocol is deemed necessary. For example, if a thunderstorm is detected, it may be determined that the UAV would endanger others not be able to withstand the storm, and thus a navigation termination is deemed desirable. In this example, the threshold is indicative of the severity of weather conditions. Examples of thresholds include wind speed, rain accumulation, ambient temperatures, geolocation, and the like, which may be measured to determine a threshold indicating a severe situation.

In an example embodiment, the navigation termination protocol may include triggering a circuit breaker to disconnect the power supply from the propelling system of the UV. This may result, for example, in a loss of fuel to an engine, or a loss of electric power to a rotor. At S440 a protective system is deployed. The protective system may decelerate, or cushion the impact, of the UV. A protective system may be, for example, a parachute or an airbag.

It should be understood that various embodiments described herein above are discussed with respect to unmanned vehicles (UVs) merely for simplicity purposes and without limitation on the disclosed embodiments. Manned vehicles, robots, or any other systems capable of controlled propulsion may be equally utilized without departing from the scope of the disclosure. Further, some embodiments are discussed with respect to unmanned aerial vehicles (UAVs). Other types of vehicles, such as fixed wing UVs, autonomous automobiles, autonomous robots, and the like, may be equally utilized without departing from the scope of the disclosure.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

It should be understood that any reference to an element herein using a designation such as “first,” “second,” and so forth does not generally limit the quantity or order of those elements. Rather, these designations are generally used herein as a convenient method of distinguishing between two or more elements or instances of an element. Thus, a reference to first and second elements does not mean that only two elements may be employed there or that the first element must precede the second element in some manner. Also, unless stated otherwise, a set of elements comprises one or more elements.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A navigation termination system of an unmanned vehicle (UV), comprising:
a plurality of sensors connected to the UV and configured to detect motion of the UV;
a power supply configured to power the movement of the UV;
a processing circuitry; and
a memory, the memory containing instructions that, when executed by the processing circuitry, configure the system to:
determine, based on sensory signals captured by the plurality of sensors, a navigation termination event;
disrupt a connection between the power supply and a motion mechanism of the UV when the navigation termination event occurs.

2. The system of claim 1, further comprising:
a protection deployment system configured to deploy when the navigation termination event occurs.

3. The system of claim 2, wherein the protection deployment system is configured to protect the vehicle and surroundings from harm when the navigation termination event occurs.

4. The system of claim 2, wherein the protection deployment system includes at least one of: a parachute, an air bag, a damper, and a landing skid.

5. The system of claim 1, further comprising:
a low power communication circuit, wherein the low power communication is configured to at least authenticate commands received from a user.

6. The system of claim 5, wherein the commands received from a user include a command to initiate the disruption of connection between the power supply and the motion mechanism.

7. The system of claim 5, wherein the communication circuit is configured to connect the system to a network, and wherein the system is further configured to receive instructions via the network regarding initiation of the navigation termination event.

8. The system of claim 1, wherein each of the plurality of sensors includes at least one of: a global navigation satellite system receiver, an accelerometer, a radar system, and an optical sensor.

9. The system of claim 1, further comprising:
a circuit breaker disposed between the power supply and the motion mechanism of the UV.

10. The system of claim 9, wherein the system is further configured to:
disrupt a connection between the power supply and the motion mechanism of the UV by switching the circuit breaker.

11. The system of claim 1, wherein the UV is an unmanned aerial vehicle.

12. The system of claim 11, wherein the motion mechanism includes a propelling device connected to the power supply.

13. The system of claim 1, wherein the navigation termination event is detected when a predetermined threshold is exceeded.

14. They system of claim 13, wherein the predetermined threshold is a measurement detected by at least one of the plurality of sensors.

15. The system of claim 13, wherein the predetermined threshold comprises at least one of: wind speed, rain accumulation, ambient temperature, and geolocation.

16. A method for terminating a navigation system of an unmanned vehicle (UV), comprising:
detecting, by a plurality of sensors connected to the UV, a motion of the UV;
determining, based on sensory signals captured by the plurality of sensors, a navigation termination event; and
disrupting a connection between the power supply and a motion mechanism of the UV when the navigation termination event occurs.

17. The method of claim 16, further comprising:
deploying a protection deployment system when the navigation termination event occurs, wherein the protection deployment system is configured to protect the vehicle and surroundings from harm when the navigation termination event occurs.

18. The method of claim 17, wherein the protection deployment system includes at least one of: a parachute, an air bag, a damper, and a landing skid.

19. The method of claim 16, further comprising:
receiving commands from a user over a network; and
authenticating the commands received from the user.

20. The method of claim 19, wherein the commands received from a user include a command to initiate the disruption of connection between the power supply and the motion mechanism.

21. The method of claim 16, wherein each of the plurality of sensors includes at least one of: a global navigation satellite system receiver, an accelerometer, a radar system, and an optical sensor.

22. The method of claim 16, wherein disrupting the connection between the power supply and the motion mechanism, further comprises:
switching a circuit breaker connected between the power supply and the motion mechanism of the UV.

23. The method of claim 16, wherein the UV is an unmanned aerial vehicle.

24. The method of claim 16, wherein the navigation termination event is detected when a predetermined threshold is exceeded.

25. They method of claim 24, wherein the predetermined threshold is a measurement detected by at least one of the plurality of sensors.

26. The method of claim 24, wherein the predetermined threshold comprises at least one of: wind speed, rain accumulation, ambient temperature, and geolocation.
